(19) United States
(12) Patent Application Publication
(10) Pub. No.: US 2025/0034014 A1
(43) Pub. Date: Jan. 30, 2025

(54) SYSTEMS AND METHODS FOR CONTROLLING AERATION

(71) Applicant: Enviromix, Inc., Charleston, SC (US)

(72) Inventors: John Koch, Wauwatosa, WI (US); David Mullins, Chicago, IL (US); Scott Mleziva, Mequon, WI (US); William King, Mt. Pleasant, SC (US); Sarah O. Elger, Cudahy, WI (US)

(21) Appl. No.: 18/785,592

(22) Filed: Jul. 26, 2024

Related U.S. Application Data
(60) Provisional application No. 63/529,555, filed on Jul. 28, 2023.

(51) Int. Cl. C02F 3/12; C02F 3/00

(52) U.S. Cl. CPC C02F 3/1278; C02F 3/006; C02F 2209/08; C02F 2209/22; C02F 2209/38; C02F 2209/44

(57) ABSTRACT

Systems and methods for enabling dynamic treatment of substances are disclosed. Such treatment conditions may include, by way of example, systems and methods for dynamically aerating wastewater within zones of a system in response to the operating parameters of at least one downstream zone.

### CROSS-REFERENCE TO RELATED APPLICATION

This application claims priority to U.S. Provisional Patent Application No. 63/529,555, filed Jul. 28, 2023, wherein the contents of the foregoing is incorporated herein in its entirety by reference.

### FIELD OF THE INVENTION

The present invention relates to systems and methods for controlling dynamic aeration adjustments to volumes of a substance within a reactor.

### BACKGROUND

Methods for aerating wastewater and other substances are known in the art. Such methods may include using aeration equipment to provide gas to wastewater or another substance.

### SUMMARY OF THE INVENTION

The present invention includes systems and methods as described herein.

In one embodiment, the present invention includes a method for a wastewater treatment process, which includes monitoring an oxygen demand in a first zone of a reactor. The method further includes dynamically adjusting a target dissolved oxygen value for a plurality of second zones that are upstream of the first zone by incrementally decreasing the target dissolved oxygen value for one or more of the plurality of second zones in response to a measured oxygen demand of the first zone being at or below a minimum threshold, incrementally increasing the target dissolved oxygen value for one or more of the plurality of second zones in response to a measured oxygen demand of the first zone is at or exceeds a maximum threshold, and maintaining the target dissolved oxygen value for the plurality of second zones when the oxygen demand of the first zone is between the minimum threshold and the maximum threshold.

In another embodiment, the present invention includes a control system for a wastewater treatment process. The system includes a reactor comprising a first zone and a plurality of second zones and one or more aeration devices positioned within the first zone and each of the plurality of second zones. The system further includes one or more airflow rate meters connected with the aeration devices in the first zone and configured for monitoring the flow rate of aeration gas to the aeration devices in the first zone of the reactor, an adjustable flow control device for each of the plurality of second zones that is connected with the aeration devices in that second zone, and a dissolved oxygen sensor connected with each of the plurality of second zones. In this embodiment, the system further includes a controller configured to continually decrease a dissolved oxygen target in one or more of the plurality of second zones to a reduced dissolved oxygen target in response to the oxygen demand of a substance in the first zone being at or below a minimum threshold, adjust one or more flow control devices to decrease the delivery of aeration gas to satisfy the reduced dissolved oxygen target, increase a dissolved oxygen target in one or more of the plurality of second zones to an increased dissolved oxygen target in response to the oxygen demand of a substance in the first zone being at or above a maximum threshold, adjust one or more flow control devices to increase the delivery of aeration gas to satisfy an increased dissolved oxygen target, and maintain the status of the flow control devices when the oxygen demand of the substance in the first zone is between the minimum threshold and the maximum threshold.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE DRAWINGS

These and other features, aspects, and advantages of the present invention are better understood when the following detailed description is read with reference to the accompanying drawings, wherein:

FIG. 1A illustrates a wastewater treatment system including a reactor having multiple zones according to an embodiment of the present invention;

FIG. 1B is a schematic view of the reactor of FIG. 1A;

FIG. 2 is a schematic view of a reactor having multiple zones according to an alternative embodiment of the present invention;

FIG. 3 is a flow chart for a method according to an example embodiment of the present invention for a series operation;

FIG. 4 is a flow chart for a method according to an example embodiment of the present invention for a sequence operation; and

FIG. 5 is a flow chart for a method according to an example embodiment of the present invention for a parallel operation

Repeat use of reference characters in the present specification and drawings is intended to represent same or analogous features or elements of the invention. Dashed lines in the figures and shading are non-structural indications to illustrate and demarcate the representative area or volume containing different zones within a system pursuant to embodiments of the present invention.

### DETAILED DESCRIPTION OF EXEMPLARY EMBODIMENTS

Reference will now be made in detail to various embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

Systems and methods of the present invention may be used in connection with various treatments or storage of substances. By way of example, the embodiments of the present invention may be utilized in the treatment of a substance, such as wastewater. In some embodiments, the present invention may include a reactor containing a volume of substance, such as wastewater, and the reactor can dynamically transition that entire volume or fractions of that volume to anaerobic, anoxic, suboxic/low DO, or aerobic environments or a combination thereof to address real-time conditions or based on other settings or parameters. One of ordinary skill in the art will appreciate that while treatment conditions may be changed instantaneously, or nearly instantaneously, the conditions of the wastewater within the volume of the environment may require some lag time to transition.

By way of example, embodiments of the present invention may include systems and methods for biological wastewater treatment processes, such as suspended growth (for example, activated sludge), encapsulated microorganisms, and fixed film processes, or a combination of said processes. In such processes, a containment unit or multiple containment units may be utilized to provide multiple environments, such as anaerobic, fermentation, anoxic, suboxic/low DO and/or aerobic environments, for respective volumes of the wastewater undergoing treatment. Such different environments may mix the activated sludge and/or provide oxygen for the removal of organic material and nutrients such as various species of phosphorous, and/or nitrogen. As used herein, an anaerobic environment includes a volume defined by an environment within the reactor that is void of both chemically bound oxygen, such as nitrate-nitrogen (NO₃-N), and dissolved oxygen. Anaerobic environments may be utilized as a step in biological phosphorus removal, forcing the release of phosphorus from the biomass cells (activated sludge) in exchange for volatile fatty acids. A fermentation environment includes a volume defined by an anaerobic environment where the primary solids, primary effluent, mixed liquor suspended solids, influent wastewater suspended solids, return activated sludge solids, or some combination thereof are allowed to stratify within an environment to promote hydrolysis and fermentation of readily biodegradable material to produce volatile fatty acids. An anoxic environment includes a volume defined by an environment within the reactor that is void of dissolved oxygen but contains chemically bound oxygen such as nitrate-nitrogen (NO₃-N). Anoxic environments may be used for a denitrification process to remove nitrate. A suboxic (also referred to as low DO) environment includes a volume defined by an environment within the reactor that has minimal/low amounts of both dissolved oxygen and chemically bound oxygen such as nitrate-nitrogen (NO3-N) present. Suboxic/low DO environments may be used to remove organic material and to convert ammonia to nitrate and nitrate to nitrogen gas, sometimes creating an environment conducive to simultaneous nitrification and denitrification. An aerobic environment includes a volume defined by an environment within the reactor that may have both dissolved oxygen and chemically bound oxygen such as nitrate-nitrogen (NO₃-N) present. Aerobic environments may be used to remove organic material, such as biochemical oxygen demand (BOD), and to convert ammonia to nitrite, and subsequently convert nitrite to nitrate.

Embodiments of the present invention may be utilized to treat a substance, such as biological wastewater treatment processes including suspended growth (for example, activated sludge), encapsulated microorganisms, and fixed film processes, or a combination of said processes. In some embodiments, the present invention may include one or more treatment conditions, such as anaerobic, fermentation, anoxic, and/or aerobic. In addition to one or more fixed environment, embodiments of the present invention may include one or more flexible environments configured to provide and dynamically transition between two or more of anaerobic, fermentation, anoxic, suboxic/low DO or aerobic environments, and combinations thereof, such as disclosed in U.S. Pat. No. 11,993,524, which is incorporated herein in its entirety by reference.

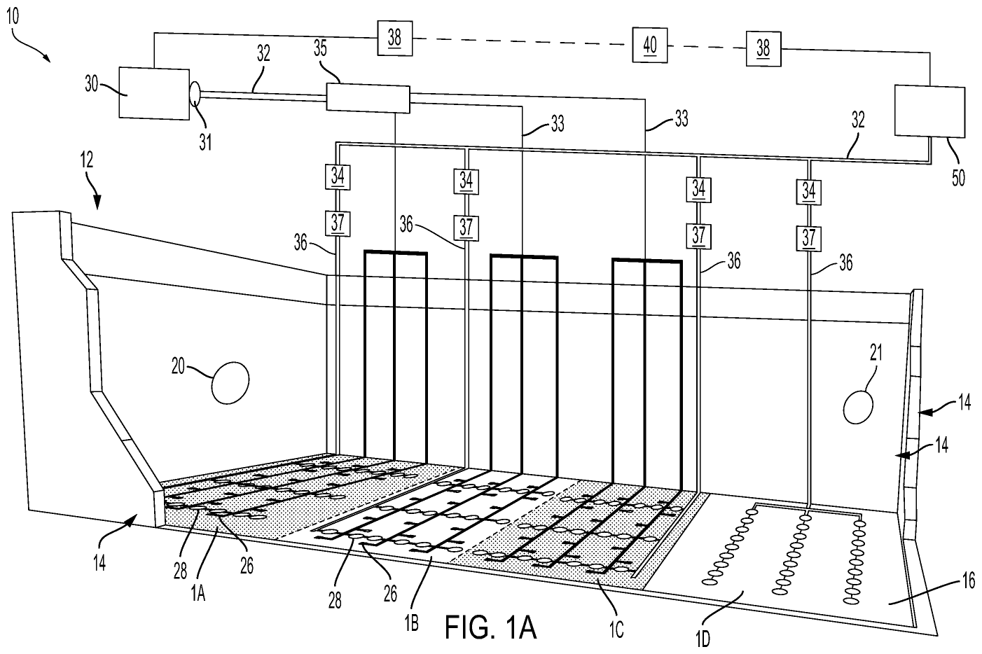

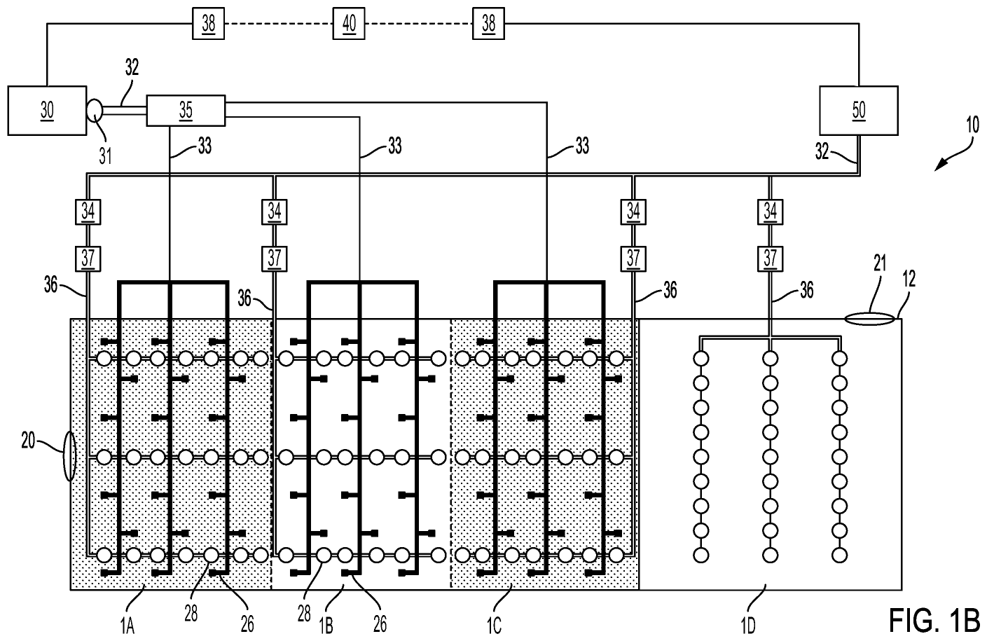

Referring to FIG. 1A and FIG. 1B, an exemplary wastewater treatment system 10 is depicted. As shown, system 10 includes a reactor 12 for wastewater, which is shown in FIG. 1A as having four sidewalls 14, and a bottom 16. Bottom 16 may have any suitable shape, such as flat or sloped.

Reactor 12 also includes an inlet 20 through which wastewater may enter reactor 12, including raw wastewater, screened wastewater, screened and degritted wastewater, primary effluent, other types of wastewater, or any combination thereof, and an outlet 21 through which wastewater may exit the reactor. Outlet 21 may exit the reactor from any of the sidewalls 14 based on the reactor 12 configuration. In some embodiments, return activated sludge (RAS) may be combined with wastewater entering reactor 12 through inlet 20 or through a different inlet. Such RAS may originate from a downstream clarifier or other solids separation devices, such as membrane separators or dissolved air floatation devices. In addition, in some embodiments internal recycle (IR) also may be transported and combined with wastewater entering reactor 12 through inlet 20. The internal recycle may originate from a downstream anaerobic, anoxic, suboxic/low DO and/or aerobic environment. In some alternative embodiments, a distinct internal recycle inlet and/or RAS inlet may be located at a position within reactor to introduce such substances separately from inlet 20. In some embodiments, a distribution pipe (not shown) may be connected to inlet 20 and may carry a portion or all of influent, which may include RAS and/or mixed liquor suspended solids (MLSS) for introducing into reactor 12. In some embodiments, a reactor may have multiple inlets and a distribution pipe may disperse the flow to one or more points within the reactor or the distribution pipe may disperse the flow to a single point within the reactor.

Although shown with a rectangular geometry in the accompanying figures, reactors of the present invention may have any suitable geometry and may comprise any suitable type of containment unit. By way of example, a reactor may be rectangular, oval, circular, concentric rings, or any other suitable shape. In some embodiments, multiple containment units, of the same type or of differing types, may be present and connected such that the wastewater passes through them sequentially or not connected such that wastewater passes thru them in parallel. In addition, reactor 12 and other reactors used for the present invention may operate in a continuous flow operation, continuous flow with intermittent discharge, batch operation, or other suitable operations.

Reactors of the present invention may include mixing devices and aerators, such as mixing devices 26 and aerators 28 as shown in FIGS. 1A and 1B. Any suitable mixing devices and aerators may be used in some embodiments of the invention. In all embodiments discussed herein, the quantity and arrangement of mixing devices and aerators within a particular zone are illustrative only and may be varied in quantity and arrangement in alternative embodiments. By way of example, alternative illustrative configurations of aerators and mixing devices are shown in U.S. Pat. No. 11,993,524, which is incorporated herein in its entirety by reference.

Aerators of the present invention may include any suitable aeration device or combination of aeration devices, such as coarse bubble diffusers, fine bubble diffusers, or other types of aeration devices may be utilized, such as jet aeration systems in which pumped fluid is expelled through openings along a header or manifold and introduces gas into the fluid stream or mechanical aeration systems in which the mechanical aerator is rotated at the surface to introduce ambient air into the substance, such as wastewater. In some embodiments, aerators may be positioned at or near a bottom of a reactor, but in other embodiments any suitable aerator positioning may be utilized. In other embodiments, an aerator could be a membrane that delivers oxygen directly to the microorganisms or liquid phase in the absence of bubbles.

Gas may be selectively provided to aerators in some embodiments of the present invention. By way of example, with continued reference to FIG. 1A, a source of gas, shown as blower 50 and blower/compressor 30, is shown. Although illustrated outside of reactor 12, blower 50 and blower/compressor 30 may be in any suitable location for a particular application, including indoor and outdoor locations or within the reactor. In other embodiments, any suitable source of gas may be utilized, such as a compressor. The source of gas may supply any suitable fluid or gas, such as atmospheric air, oxygen enriched fluid or gas, pure oxygen, and/or other gases, and the term “gas” is generically used herein to encompass all such options. In some embodiments, multiple sources of gas may be present, such as a separate gas source for mixing devices and aerators, such as shown in FIGS. 1A and 1B. A source of gas may be utilized to provide gas to a single containment unit or to multiple containment units, including containment units that may be related and/or unrelated in a system. In some embodiments, multiple sources of gas may be utilized. In addition, a source of gas may supply only the containment unit(s) that form part of the system or, in other embodiments, a shared gas source may supply gas to other systems as well. In still other embodiments, multiple sources of gas, such as multiple blowers, may be utilized to supply gas to various aerators.

In the depicted embodiment, blower 50 is connected to supply lines 32 and to headers 36 to provide gas to the aerators 28 in reactor 12 with a blower/compressor 30 connected to supply lines 32 and to headers 33 to provide gas to the mixing devices 26 in reactor 12. A flow control device, such as modulating valves 34 shown in FIGS. 1A and 1B, may be positioned on headers 36 to regulate the flow of gas from the blower 50 to an aerator. In some embodiments, such as shown in FIG. 1A and FIG. 1B, a modulating valve 34 is present on each supply line such that each aerator may be individually controlled and regulated. Any suitable flow control device may be utilized, such as a throttling or actuating valve. In other embodiments of the invention, valves 34 may be placed in alternative positions, such as within reactor 12. In addition, other types of valves or structures to control or direct the flow of gas may be utilized within alternative embodiments of the present invention. For example, individual butterfly or other types of open/close or modulating valves with an actuator, either electro-mechanical or pneumatic, could be employed in some embodiments of the present invention. In still other embodiments, instead of multiple valves, a system may utilize one or more multi-channel valves that are capable of selectively directing gas to one or more particular headers 36. By way of further example, a single multi-port rotating valve may be utilized in some embodiments of the present invention. In addition, an airflow meter 37 may be positioned on each header 36 either upstream or downstream from the modulating valve. Similarly, mechanical controls, such as for power or intensity, may be used to control mechanical aeration devices in other embodiments.

In the depicted embodiment shown in FIG. 1A and FIG. 1B, blower/compressor 30 is connected to supply lines 32 and to headers 33 to provide gas to the mixing devices 26 in reactor 12. A conventional regulator 31 or a throttling valve (not shown) may be positioned to regulate the flow of gas from the blower/compressor 30 or centralized air supply. In addition, a flow regulation device, such as valves 35 (which may also be referenced as a valve manifold), may be placed along the supply line to regulate the flow of gas from the compressor 30 to the content of reactor 12 and to selectively permit gas flow to some or all of mixing devices 26 within reactor 12. Any suitable valve may be utilized, such as a throttling or actuating valve. In other embodiments of the invention, valves 35 may be placed in alternative positions, such as within reactor 12. In addition, other types of valves or structures to control or direct the flow of gas may be utilized within alternative embodiments of the present invention. For example, individual butterfly or other types of open/close or modulating valves with an actuator, either electro-mechanical or pneumatic, could be employed in some embodiments of the present invention. In still other embodiments, instead of multiple valves, a system may utilize one or more multi-channel valves that are capable of selectively directing gas to one or more particular headers 33. By way of further example, a single multi-port rotating valve may be utilized in some embodiments of the present invention.

Mixing devices 26 are also shown in FIGS. 1A and 1B. Any suitable mixing devices may be used in connection with embodiments of the present invention. By way of example, mechanical mixing devices, propeller mixing devices, jet and pump mixing devices, low pressure air diffusers, compressed gas mixing devices, any other suitable mixing device, or a combination of different mixing devices may be utilized. In some embodiments, mixing devices 26 may provide vertical mixing within reactor 12, such as when mixing device 26 disperses a gas or liquid in a vertical manner from or near bottom 16 in an upward direction to mix the substance in the reactor. In some embodiments, mixing devices 26 may provide top down vertical or hyperbolic mixing, while in other embodiments, mixing devices 26 may stir the tank to provide mixing with respect to the horizontal plane. In some embodiments, mixing devices 26 may float on the surface of the tank, while in other embodiments, mixing devices are mounted at or near the bottom of reactor 16 or between the bottom of the reactor 16 and the top of the reactor. In some embodiments, mixing devices may be configured to release periodic bursts of gas into the reactor such as described in U.S. Pat. Nos. 8,505,881, 8,323,498, and U.S. Published Patent Application No. 2019/0100449, each of which is incorporated herein in its entirety by reference.

Controllers may be used in some embodiments of the present invention to selectively control the operation of aerators and/or mixing devices, including the activation, deactivation, and flow rate, and intensity of such aerators and mixing devices. By way of example with reference to FIG. 1A, valves 34 controlling aeration and valves 35 controlling mixing are in communication with controller 38. Although illustrated as located outside of reactor 12, controllers of the present invention may be located in any suitable placement. Controller 38 may be any suitable device for controlling the gas flow, such as opening valves, closing valves, and adjusting the degree that a valve is opened. In some embodiments, controller 38 may be a programmable logic controller. As shown in FIGS. 1A and 1B, controller 38 is in communication with valves 34 and valves 35. In alternative embodiments using mechanical aeration devices, a controller may operate mechanical controls of such mechanical aeration devices, such as power and intensity. In some embodiments, multiple controllers may be employed, such as a controller for controlling aerators and a separate controller for controlling mixing devices.

In addition to gas release mixing devices that may be controlled in the manner described above, other types of mixing devices, such as mechanical mixing devices, may be utilized in other embodiments. A controller may be used to activate, deactivate, or change the mixing intensity of other mixing devices such as by toggling power transmission, using variable speed drives, adjusting the rotation rate of the motor or gears, changing the rotation or circulation rate of a propeller or agitator, or using any other suitable control mechanism or process.

In some embodiments, controller 38 may be in communication with a control device 40, such as shown in FIG. 1A. Control device 40 may include any machine having processing capacity, such as, by example, a machine having a processor, a memory, and an operating system. In some embodiments, control device 40 may include an interface for inputting such manual instruction. By way of example, and without limitation, control devices may include one or more of a personal computer, handheld computer, microcontroller, PLC, smartphone, and/or tablet.

In some embodiments, controller 38 and/or control device 40 may be connected to a wireless and/or wired network. In addition, controller 38 and/or control device 40 may be located within controller box, in proximity to reactor 12, or at a remote location, such as within a treatment facility or at another site. In still other embodiments, a controller and a control device may be a single device. In addition, an existing facility may have existing controllers or control panels or hardware and the present invention could be interfaced with those existing systems, such as by loading software to perform the processes described herein and communicate with the previously-existing structures. Furthermore, as noted, controller 38 and/or control device 40 may be remotely accessible, and it may be configured to a network, cloud, or internet connection. In addition, controller 38 and/or control panel 40 may permit an operator to manually control the processes and system components, such as manually overriding the automatic control and activating or deactivating aeration to the wastewater. Controller 38 and/or control device 40 may also be configured with a storage medium to record and archive system parameters and operating conditions, wherein such historical information may be an optional factor utilized in controlling the mixing and/or aeration in one or more zones.

As used herein, reference to “in communication with” indicates that data and/or signals are transferrable between the referenced components, and such reference includes both physical connections and wireless connections. In addition, “in communication with,” whether used in connection with data or otherwise, also includes embodiments in which the referenced components are in direct connection (i.e., directly connected to each other) as well as indirect connections, such as when data is transmitted through an intermediate component and either relayed in the same format or converted and then relayed to the referenced component. Furthermore, as used herein, the terms “connected” and “attached,” and variations of those terms, includes, unless indicated otherwise by the context, components that are in direct connection and components that are indirectly connected by way of other components.

Embodiments of the present invention may include multiple zones within a reactor. As used in the present invention, a zone is defined as the volume of a reactor having one or more commonly controlled aerators positioned therein, i.e., such aerator(s) is/are activated, deactivated, and the airflow rates, horsepower, or other means to control gas delivery are commonly controlled. In all figures, dashed lines and shading are used to indicate and demarcate the distinct zones illustrated within a figure, wherein shading is simply alternated to show such separate zones. In some embodiments, some or all zones may be separated by any suitable type fixed, temporary, or permanent physical barrier, such as a wall, baffle, or curtain. In other embodiments, such as shown in FIG. 1A, some or all barriers may be omitted from a reactor such that there is no physical separation between some or all zones.

For example, as shown in FIG. 1A, four sets of independently controlled aerators define four distinct zones. Zone 1A includes aerators 28 that are commonly controlled by a valve 34 in communication with controller 38, zone 1B includes other aerators 28 that are commonly controlled by a valve 34 in communication with controller 38, zone 1C includes still other aerators 28 that are commonly controlled by a valve 34 in communication with controller 38, and zone 1D, which is a monitored aerated zone as described in more detail below, includes still other aerators 28 that are commonly controlled by a valve 34 in communication with controller 38. As shown in FIG. 1A, the aerators within each zone are commonly controlled and are also controlled independently of aerators in other zones. Mixing devices may also be present in some zones, such as in FIG. 1A in which mixing devices 26 are present in zones 1A, 1B, and 1C. However, in some embodiments, a monitored aerated zone may not have any mixing devices separate from aerators.

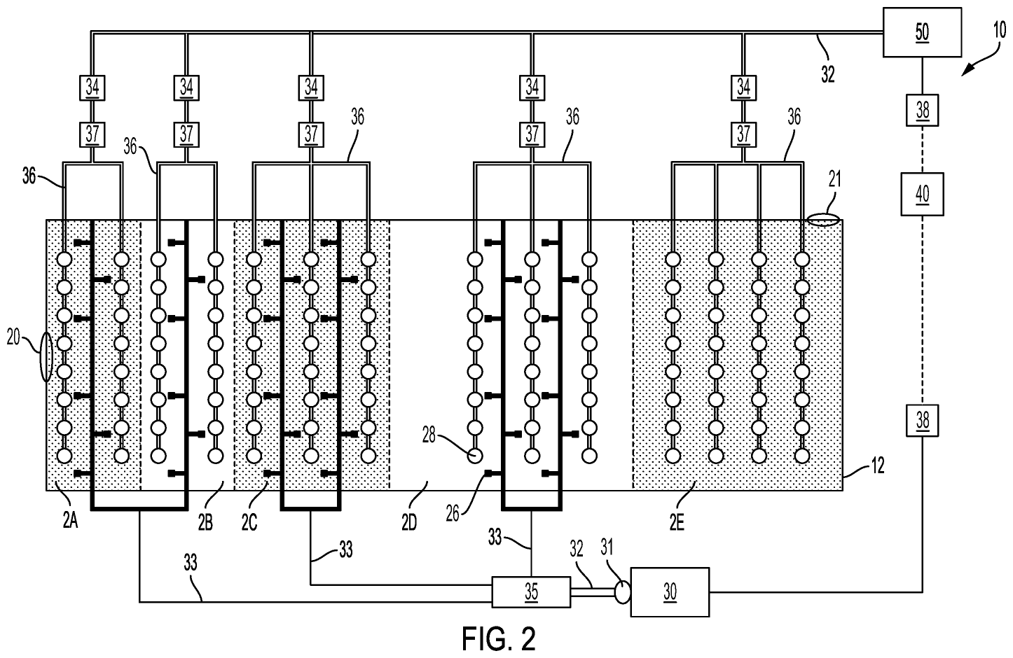

As another example, FIG. 2 shows another illustrative reactor in which a plurality of aerators in each zone are connected to blower 50 via a unique valve 34, such that the plurality of aerators are commonly controlled and thereby define a zone. As shown, reactor 12 includes zone 2A, zone 2B, zone 2C, zone 2D, and zone 2E, wherein zone 2E is a monitored aerated zone as described in more detail below. Zone 2A includes a first group of aerators 28, zone 2B includes a second group of aerators 28, zone 2C includes a third group of aerators 28, zone 2D includes a fourth group of aerators 28, and zone 2E includes a fifth group of aerators 28. In addition, zone 2A, zone 2B, zone 2C, and zone 2D also include mixing devices 26.

In some embodiments, the present invention may include at least one monitored aerated zone and at least one additional zone. As used herein, a monitored aerated zone is a zone that is downstream of at least one other zone, wherein certain properties are monitored in the monitored aerated zone, and wherein aeration in one or more zones that are upstream from the monitored aerated zone is independently controlled in each such zone, at least in part, in response to the monitored parameters in the monitored aerated zone. The monitored aerated zone can be located at any position within a reactor but, as indicated herein and explained below, the conditions related to the monitored aerated zone will determine the aeration process in one or more zones that are upstream of the monitored aerated zone, namely by activating, deactivating, or increasing or decreasing the aeration in such one or more upstream zones. The monitored aerated zone aeration supply may be actively or passively controlled, active control may include airflow control, DO control, ammonia based aeration control, or other methods of active aeration control.

As used herein, upstream means that in a flow reactor with influent entering in one end of the reactor and effluent exiting at the opposite end of the reactor, upstream is located in the direction of the influent entering the reactor. By way of example, zones 1A, 1B, and 1C are upstream of zone 1D in FIG. 1A and wherein zone 1A is the most upstream zone of zone 1D. In some embodiments, the monitored aerated zone may be located at or near the end of the reactor, wherein the end of the reactor is the zone or area where the effluent exits the reactor. By way of example with reference to FIG. 1A, zone 1D serves as a monitored aerated zone when aeration in one or more upstream zones 1A, 1B, or 1C is controlled in response to the parameters observed for zone 1D.

As noted above, parameters may be monitored in a monitored aerated zone and aeration in one or more upstream zones may be adjusted in response to such monitored aerated zone parameters. In some embodiments of the present invention, a minimum airflow rate and/or a maximum airflow rate may be associated with aerators in a monitored aerated zone. Given that a monitored aerated zone may not include mixing devices, such a minimum airflow rate may be used to ensure that suitable aeration is provided for adequately mixing the substance, such as wastewater, within a monitored aerated zone even when oxygen supplied by aeration of that substance exceeds the oxygen demand within the monitored aerated zone. Similarly, a maximum airflow rate may be used to ensure that excessive gas is not provided to the monitored aerated zone even when the oxygen demand of a substance in the monitored aerated zone would otherwise suggest increasing oxygen delivery. When airflow to a monitored aerated zone is between the minimum airflow rate and the maximum airflow rate, referenced herein as being within a holding range, then no aeration adjustments are required to upstream zones. However, as such and as described in detail below, embodiments of the present invention may be utilized to incrementally increase or decrease the target DO value in upstream zones in response to airflow in the monitored aerated zone falling outside of the holding range (i.e., equal to or below the minimum airflow rate or equal to or above the maximum airflow rate). In some embodiments, such increases or decreases may only take place after the airflow in the monitored aerated zone has fallen outside of the holding range for a requisite period of time, which may be from 1 minute to 60 minutes (including each intermittent value therein).

In other embodiments of the present invention, a minimum dissolved oxygen concentration and/or a maximum dissolved oxygen concentration may be associated with aerators in a monitored aerated zone. Given that an oxygen residual may be desirable, such a minimum dissolved oxygen concentration may be used to ensure residual dissolved oxygen is maintained within the substance, such as wastewater. Similarly, a maximum dissolved oxygen concentration may be used to ensure that excessive gas is not provided to the monitored aerated zone even when the oxygen demand of a substance in the monitored aerated zone would otherwise suggest increasing the oxygen delivery. When the dissolved oxygen concentration in a monitored aerated zone is between the minimum dissolved oxygen concentration and the maximum dissolved oxygen concentration, referenced herein as being within a holding range, then no aeration adjustments are required to upstream zones. However, as described in detail below, embodiments of the present invention may be utilized to incrementally increase or decrease the target DO value in upstream zones in response to dissolved oxygen concentrations in the monitored aerated zone falling outside of the holding range. In some embodiments, such increases or decreases may only take place after the DO in the monitored aerated zone has fallen outside of the holding range for a requisite period of time, which may be from 1 minute to 60 minutes (including each intermittent value therein).

In still other embodiments of the present invention, a minimum dissolved oxygen concentration combined with an increasing reactor total airflow rate and/or a maximum dissolved oxygen concentration combined with a decreasing reactor total airflow rate may be associated with aerators in a monitored aerated zone. Given that a minimum oxygen residual may be desirable and an increasing reactor total airflow rate is signaling increasing oxygen demand within the reactor, such a minimum dissolved oxygen concentration and increasing reactor total airflow rate may be used to ensure residual dissolved oxygen is maintained within the substance, such as wastewater. Similarly, a maximum dissolved oxygen concentration and a declining reactor total airflow rate may be used to ensure that excessive gas is not provided to the monitored aerated zone. When the dissolved oxygen concentration in a monitored aerated zone is between the minimum dissolved oxygen concentration and the maximum dissolved oxygen concentration, referenced herein as being within a holding range, then no aeration adjustments are required to upstream zones. However, as described in detail below, embodiments of the present invention may be utilized to incrementally increase or decrease the target DO value in upstream zones in response to dissolved oxygen concentrations in the monitored aerated zone falling outside of the holding range in combination with increasing or decreasing reactor total airflow rates. In some embodiments, such increases or decreases of target DO values in upstream zones may only take place after the moving average of the reactor total airflow rate has declined or increased over a period of time which could be 15 minutes to 120 minutes in length, after the DO concentration within the monitored aerated zone has fallen outside of the DO holding range.

### Upstream Aeration Reduction

As indicated above, parameters of the monitored aerated zone, such as aeration airflow rate or mechanical features, such as rotating speed of a mechanical aeration device, may be utilized to reduce aeration in one or more upstream zones. By way of example, one airflow threshold for the monitored aerated zone may be based on mixing limited conditions, wherein mixing limited conditions may be defined by an airflow rate per square foot of reactor area. In some embodiments, a mixing limited rate may be set at 0.12 scfm/ft² of reactor surface area, wherein scfm indicates airflow as standard cubic feet per minute. In other embodiments, alternative rates of airflow per reactor surface area may be used based on how conservative the approach is—a more conservative approach may use a higher rate, while a less conservative approach may use a lower rate. In some embodiments, a mixing rate may be selected from the range of 0.05 to 2.0 scfm/ft², including each intermittent rate therein. Using a mixing limited rate of 0.12 scfm/ft², a reactor that is 100 ft long by 30 ft wide would have a reactor area of 3,000 ft². The mixing limited airflow value may be calculated by using the following equation:

$$Mixing Limited Condition Value \times Reactor Area = Mixing Limited Airflow$$

Applying this equation to the example reactor discussed above yields the following:

$$0.12 scfm / {ft}^{2} \times 3 , 000 {ft}^{2} = 360 scfm$$

Alternative rates of airflow could be based on airflow rate per unit volume of reactor or portion of reactor instead of per surface area of reactor. In some embodiments, a mixing limited airflow rate may be set at 1.25 scfm/1,000 gallons of reactor volume. In other embodiments, a mixing limited airflow rate may be set at 15 scfm/1,000 cubic feet of reactor volume. Any suitable measurement of airflow and reactor volume can be utilized.

In this example, the airflow within the monitored aerated zone being at or below the mixing limited airflow rate, namely 360 scfm, indicates that increased aeration is required in the monitored aerated zone in order to adequately mix the substance, particularly when there are no mixing devices independent of aeration devices present or operating. However, as a result of the continued or increased aeration in the monitored aerated zone under mixing limited conditions, it may be useful for the substance, such as wastewater, in the monitored aerated zone to exert a greater oxygen demand in the monitored aerated zone such that air supply to meet oxygen demand is equal to or greater than the air supply to meet mixing requirements. As a result, a controller, such as controller 38 in FIG. 1A, may automatically and systematically reduce the dissolved oxygen concentration in one or more zones upstream of the monitored aerated zone. In some embodiments, a controller may reduce the dissolved oxygen concentration in one or more upstream zones by lowering a target dissolved oxygen value for each zone and incrementally modulating the valve position controlling the aeration flow rate in some or all of such upstream zones to achieve their reduced target dissolved oxygen concentration. By the controller reducing the amount of aeration being delivered to one or more upstream zones of the reactor, the substance in the reactor in such upstream zone(s) will receive less oxygen. As a result, when the substance flows downstream to the monitored aerated zone where aeration is taking place, the substance will exert a higher demand for such oxygen. In this regard, the oxygen demand of the substance in the reactor has been effectively “pushed” or “shifted” downstream towards the monitored aerated zone to increase the oxygen uptake rate in the monitored aerated zone. Given that aeration gas will provide for mixing the substance in the monitored aerated zone, the oxygen provided from that process will be consumed by the substance given the “pushed” or “shifted” oxygen demand to that downstream monitored aerated zone. As shown by this example, the present invention provides a dynamic system and method for treating a substance within an entire system while shifting oxygen demand in various zones to eliminate mixing limited conditions.

The present invention may provide multiple advantages by “pushing” or “shifting” the oxygen demand towards the downstream portion of the reactor. A first advantage may be better management of the carbon entering the reactor. When zones upstream in the reactor are operated as anaerobic, anoxic, suboxic/low DO or aerobic environments, they may more efficiently utilize the influent carbon entering the reactor than when those same zones found further downstream in the reactor. More efficient utilization of the carbon may mean removal of the carbon with lower energy input and/or prioritization of using the carbon for biological nutrient removal. A second advantage may be to reduce DO concentrations leaving the effluent of the reactor. High dissolved oxygen (DO) concentrations at the end of the reactor may result in residual DO in the return activated sludge (RAS) stream, which may cause negative impacts on anaerobic or suboxic/low DO or anoxic environments that the RAS stream enters. High DO concentrations at the end of the reactor may also result in residual DO in the internal recycle (IR) stream, which may cause negative impacts on anoxic environments that the IR stream enters. High DO concentrations, such as those greater than 2 mg/L in some embodiments, at the end of the reactor may indicate that the system delivered excessive oxygen, and therefore wasted energy, compared to the energy input normally required for BOD and NH4 treatment.

Any aeration air introduced to a process that is not necessary to meet the oxygen demand while maintaining the desired residual DO concentration is considered in excess and as such, providing said air is a waste of energy. By “pushing” or “shifting” the oxygen demand to the monitored aerated zone, the aeration supplied to that zone for mixing may also be used to satisfy the oxygen demand of the substance in that monitored aerobic zone such that excess DO is reduced or eliminated.

In some embodiments, systems and methods of the present invention may utilize a series operation or a parallel operation for systematically modifying aeration in zones upstream from a monitored aerated zone based on the conditions of the monitored aerated zone. For example, with reference to FIGS. 1A and 1B, three zones, namely zones 1A, 1B, and 1C, are upstream of the monitored aerated zone, which is zone 1D. Each of zones 1A, 1B, and 1C may have its own associated minimum DO setpoint and a maximum DO setpoint, which are configured for each particular system in manners known in the art. In series operation, the DO target within one individual upstream zone, such as one of zones 1A, 1B, and 1C, is reduced incrementally and independent of the other zones such that the controller decreases the aeration provided to that zone as described above. In some embodiments, such reduction may take place by reducing the target DO value for that individual upstream zone and then controlling the aeration delivery to that zone to reach and maintain that reduced target DO value. A controller may effectuate such aeration reductions by incrementally closing a valve, such as valve 34, used for aeration in that particular zone or by otherwise adjusting the aeration delivery as described above.

Following an incremental reduction to the aeration in one individual upstream zone, a delay period may take place during which the aeration operation in the system is held constant and the parameters of the monitored aerated zone remain observed. Such delay periods may be of any suitable length, such as from five to sixty minutes in some embodiments, including each intermittent value and range therein. In some embodiments, the delay period is selected by one skilled in the art, and in other embodiments the delay period may be calculated based on the hydraulic retention time of the individual zone or of the entire tank, which accounts for the time for a substance to travel between various zones of a reactor. As an example, the hydraulic retention time of the entire tank is the time it takes a volume of water to travel from the inlet to the outlet of said tank. In this example, the hydraulic retention time is the total volume of the tank divided by the flow rate in units of volume per time that enters the tank, resulting in a calculated time that is the hydraulic retention time, measured in hours or minutes, for example. If the airflow of the monitored aerated zone is within its holding range following the delay period, then aeration in the entire system may be maintained in its then current state. Alternatively, if the airflow in the monitored aerated zone remains outside of its holding range following that delay, i.e., at or below the minimum airflow rate or at or above the maximum airflow rate, then another incremental reduction to the same upstream zone is implemented in the same manner as previously described.

Throughout this process, the DO concentration of the substance in that upstream zone subject to aeration adjustments may be monitored, such as by using a DO probe in that zone that is in communication with a controller. In other embodiments, an oxidation reduction potential (ORP) probe or other suitable probes for determining dissolved oxygen concentration, directly or indirectly, may be used similarly as the DO probe discussed herein. This cycle of delays and incremental reductions for that particular upstream zone may be continued until the monitored aerated zone airflow reaches its holding range, at which time the system may continue to maintain the existing aeration parameters. Alternatively, the cycle may continue until that particular upstream zone undergoing aeration adjustments reaches an overall minimum DO setpoint for that zone, at which time a controller may terminate aeration to that zone (but may optionally continue or initiate operation of mixing devices in that zone).

In a series operation, after a minimum DO setpoint for one upstream zone has been reached so that aeration is terminated for that zone, then the controller commences a similar cycle of incremental reduction of aeration in another zone that is upstream from the monitored aerated zone, which may continue until either the monitored aerated zone reaches its holding range or until that upstream zone undergoing aeration adjustment reaches its own minimum DO setpoint.

In such a series operation, the series may continue in the same manner to multiple zones upstream of the monitored aerated zone until the monitored aerated zone has a suitable airflow between its minimum and maximum airflow rates, at which time the system will be maintained in its then existing aeration process until aeration airflow in the monitored aerated zone is again outside of its holding range, i.e., reaches or falls below its minimum airflow rate or reaches or exceeds its maximum airflow rate. Such systems and processes are further illustrated with the subsequent examples herein.

A series operation of the present invention may take place in either Forward Order, Reverse Order, or Specified Order. In Forward Order, once aeration airflow reaches or falls below a minimum threshold for the monitored aerated zone, such as a mixing limited airflow value, the controller first adjusts aeration airflow in a first zone located closest to the influent location in the reactor, such as zone 1A in FIG. 1A, such as by adjusting a target dissolved oxygen setpoint, and subsequently, using the process described above, adjusts aeration airflow to subsequent zones in a downstream order, such as such zones 1B and/or 1C. By way of example with continued reference to FIG. 1A, if aeration is incrementally reduced in zone 1A until zone 1A reaches its minimum DO setpoint, then the controller may terminate aeration (but may continue or initiate operation of mixing devices) for zone 1A. The controller then begins adjusting aeration for zone 1B using the process described above, and that cycle will repeat for zone 1B. Once the minimum DO setpoint is met for zone 1B, the controller may terminate aeration (but may continue or initiate operation of mixing devices) for zone 1B. Finally, the controller then begins adjusting aeration for zone 1C using the process described above, and that cycle will repeat for zone 1C. Once the minimum DO setpoint is met for zone 1C, the controller may terminate aeration (but may continue or initiate operation of mixing devices) for zone 1C. Such adjusting from an upstream zone to one or more downstream zone(s) in a series operation, such as in the foregoing example, is referenced herein as “Forward Order.” If at any time during a series operation the airflow rate for the monitored aerated zone is in the holding range, then aeration within the zones may be maintained in its current operating state until the airflow rate for the monitored aerated zone falls outside of the holding range.

In another Forward Order series operation example with reference to FIG. 1A, zone 1A may not have its aeration modified in response to a triggering event in the monitored aerated zone, and zone 1B may first transition to a lower aeration airflow followed by downstream zone 1C, which illustrates that in some embodiments all upstream zones in a system, such as zone 1A in this example, may not be included within a particular series operation of the present invention.

In yet another Forward Order series operation example with reference to FIG. 1A, zone 1A may first modify its aeration following in response to a triggering event in the monitored aerated zone in the manner described above, and then zone 1C may next transition to a lower aeration airflow, wherein despite proceeding in Forward Order zone 1B is not included in the series operation.

In a “Reverse Order” operation, a first zone to adjust the DO target and transition to a lower aeration airflow may be a zone located closer to the monitored aerated zone and downstream of any subsequent zone(s) in which DO targets and aeration are modified using the same processes described above. In other words, the series operation may proceed in an upstream sequence for Reverse Order. With reference to FIG. 1A, such a Reverse Order may include the controller first reducing the target DO value for zone 1C in a cycle of incremental reductions and delays as described above until the controller terminates aeration to that zone when its minimum DO setpoint has been reached. Subsequently, the controller would incrementally reduce the target DO value for zone 1B and reduce aeration as described above until the controller terminates aeration to that zone when the minimum DO setpoint has been reached for zone 1B. Finally, after aeration for zone 1B has been terminated, the controller would incrementally reduce the target DO value for zone 1A and reduce aeration as described above until the controller terminates aeration to that zone when the minimum DO setpoint has been reached for zone 1A. In the same manner as described above for Forward Order, some embodiments using the Reverse Order may include such processes for either some or all upstream zones provided that the zones are sequentially treated in order from most downstream to most upstream relative to the monitored aerated zone. In addition, as described above, such operations may be ceased and aeration of the system held constant at any time that the monitored aerated zone is within its holding range.

In a “Specified Order” operation, once aeration airflow reaches or falls below a minimum threshold for the monitored aerated zone, the controller first adjusts aeration airflow in a first upstream zone as selected on the controller 38, such as zone 1B in FIG. 1A, such as by adjusting a target dissolved oxygen setpoint, and subsequently, using the process described above, adjusts aeration airflow to subsequent upstream zones in a Specified Order, such as zone 1C followed by zone 1A. The Specified Order may be selected by a user on the controller 38 and may be any combination and sequence of any number of zones located upstream of the monitored aerated zone. In the same manner as described above for Forward and Reverse Order, some embodiments using the Specified Order may include such processes for either some or all upstream zones provided that the zones are sequentially treated in the Specified Order. In addition, as described above, such operations may be ceased and aeration of the system held constant at any time that the monitored aerated zone is within its holding range.

In an alternative series operation, referenced herein as a sequence operation, aeration changes in upstream zones may be serially implemented. By way of example with reference to FIGS. 1A and 1B, once aeration airflow reaches or falls below a minimum threshold for the monitored aerated zone, such as a mixing limited airflow value, the controller first adjusts aeration airflow in a first zone located closest to the influent location in the reactor, such as zone 1A in FIG. 1A, and subsequently, using the process described above, adjusts aeration airflow to subsequent zones in a downstream order, such as such zones 1B and/or 1C. However, unlike the prior examples of series operation that may complete reduction of aeration to a single upstream zone to its minimum DO setpoint, a controller in a sequence operation may first adjust aeration airflow in a first zone located closest to the influent location in the reactor, such as zone 1A in FIG. 1A, and next after the previously-described delay period, adjust aeration airflow to subsequent zones in a downstream order, such as such zones 1B and/or 1C regardless of whether zone 1A has achieved a minimum DO setpoint. In this operation, aeration to zone 1A is not incrementally reduced until proceeding to incrementally reduce aeration in another upstream zone, but instead the aeration reductions are cycled in sequence through the relevant upstream zones. After aeration to zone 1C has been reduced, aeration to zone 1A may be further incrementally reduced. If the minimum DO setpoint is reached for any such upstream zone, then further reductions may be ceased for that particular zone. A sequence operation may be operated in Forward Order or Reverse Order. As in the previously described embodiments, if at any time during a sequence operation the airflow rate for the monitored aerated zone is within its holding range, then aeration within the zones may be maintained in their current operating state until the airflow rate for the monitored aerated zone falls outside of the holding range, i.e., is at or below the minimum airflow rate or at or above the maximum airflow rate.

In yet other embodiments, systems and methods of the present invention may operate in a parallel operation instead of in a series or sequence operation. In such embodiments, once a triggering event is indicated from the monitored aerated zone, such as reaching or falling below a minimum threshold, the target DO value and aeration in multiple zones upstream of the monitored aerated zone, or potentially all other such upstream zones, may be simultaneously and incrementally adjusted at the same time, rate, percentage, and/or incremental step. The target DO value and aeration for such zones may be simultaneously or nearly simultaneously reduced by an increment and then followed by a delay period. Following the delay period, the target DO value and aeration to such zones may be simultaneously reduced again. Such simultaneous and incremental reduction and delay cycles for such upstream zones may continue until all upstream zones reach their minimum DO setpoint, after which aeration will be terminated to such zone(s) (but may continue or initiate operation of mixing devices). In such instances, aeration in all upstream zones in the parallel operation may be simultaneously terminated in some embodiments, wherein aeration in the upstream zones in the parallel operation may be phased out in other embodiments. In addition, if any particular upstream zone reaches its minimum DO setpoint, then the DO target value for that zone may be maintained while incremental adjustments continue for other particular upstream zones in the parallel operation. Each zone reaching its minimum DO setpoint may occur simultaneously or at different times for the different zones depending, for example, on the starting parameters in a particular zone. In addition, at any time that the monitored aerated zone has an airflow rate in the holding range, then the aeration adjustments to upstream zones may cease and aeration of the system may be continued in its then existing conditions until the monitored aerated zone is no longer in its holding range.

By way of example of a parallel operation with reference to FIG. 1A, each of zones 1A, 1B, and 1C may reduce their target DO value at the same time by the same interval or by the same percentage, regardless of whether the target DO value is the same in each reactor. In some embodiments the interval is set at a fixed value selected by one skilled in the art, such as 0.1 mg/L. In other embodiments the interval may be selected based on a fraction of the maximum DO setpoint. For example, if the maximum DO setpoint is 2.0 mg/L, the interval may be 0.2 mg/L or if the maximum DO setpoint is 1.0 mg/L, the interval may be 0.1 mg/L. In yet other embodiments the interval may change as the target value increases or decreases. For example, when the target DO value is greater than 1 mg/L, the interval may be 0.1 mg/L, and when the target DO value is between 0.5 and 1.0 mg/L, the interval may be 0.08 mg/L, and when the target DO value is below 0.5 mg/L, the interval may be 0.005 mg/L. As an example of how the target DO value reduces by a set fixed interval of 0.1 mg/L, a starting target DO value in zone 1A may be 1.5 mg/L, the starting target DO value in zone 1B may be 1.0 mg/L, and the starting target DO value in zone 1C may be 0.5 mg/L. Intervals may be set in the same manner for a series or sequence operation.

When the monitored aerated zone calls for an incremental reduction of the target DO value and a parallel operation is utilized, then n−1 (next) target DO value in zone 1A would be 1.4 mg/L, the next target DO value in zone 1B would be 0.9 mg/L, and the next target DO value in zone 1C would be 0.4 mg/L, and the controller would adjust aeration to each zone based on such dynamically adjusted target values. When the controller determines that the monitored aerated zone requires another incremental reduction of the target DO value, then the n−2 target DO value in zone 1A would be 1.3 mg/L, the n−2 target DO value in zone 1B would be 0.8 mg/L, and the n−2 target DO value in zone 1C would be 0.3 mg/L. In this example, the controller may continually impose further aeration reductions in such upstream zones in response to the monitored aerated zone parameters as described above until the monitored aerated zone is within its holding range, at which time aeration in the system may be maintained its current operation, or until any particular zone reaches a minimum DO setpoint for that zone, at which time the controller would terminate aeration in that zone but operation of any mixing devices may be initiated or continued in that zone, or until all particular upstream zones reach their minimum DO setpoint and aeration is terminated to such zones (either simultaneously or in a sequential manner). Parallel operation may include all upstream zones from a monitored aerated zone or only some upstream zones from a monitored aerated zone.

In some further embodiments, a single upstream zone from a monitored aerated zone may have its aeration process adjusted in response to the parameters in the monitored aerated zone using the same process above. For example, with reference to FIG. 1A, only one of zone 1A, zone 1B, and zone 1C may be adjusted in the manners described above in some embodiments.

### Upstream Aeration Increase

In some embodiments, systems and methods of the present invention may be used to increase the aeration in one or more zones upstream of a monitored aerated zone based on the parameters of the monitored aerated zone. For example, an increasing oxygen demand in the monitored aerated zone may be determined by monitoring the airflow rate in the monitored aerated zone. In response to the airflow rate in the monitored aerated zone reaching or exceeding a threshold, such as a predetermined value, a controller may initiate or increase the aeration to one or more upstream zones of the monitored aerated zone in order to lower the oxygen demand in the monitored aerated zone. In some embodiments, the maximum airflow rate may be based on an airflow rate per diffuser. As an example, the maximum airflow rate for the monitored aerated zone may be calculated as 2 scfm/diffuser multiplied by the number of diffusers in the monitored aerated zone. The specific airflow rate per diffuser may range between 0.5-3.0 scfm/diffuser and may fall outside of said range depending on the type of diffuser. In other embodiments, the maximum airflow rate may be based on a set value determined by one skilled in the art. In yet other embodiments, the maximum airflow rate in the monitored aerated zone may be a factor of the minimum airflow rate, such as two or three times the minimum airflow rate. In yet other embodiments, the maximum airflow rate in the monitored aerated zone may be based on the airflow rate per surface area or volume of the monitored aerated zone. In such instances, as in the prior descriptions above, aeration may be adjusted to zones upstream of the monitored aerated zone when the monitored aerated zone is outside of its holding range.

In other embodiments, initiating or increasing the aeration in one or more zones upstream of a monitored aerated zone may be based on changes in parameters measured at the inlet 20 or a position prior to the reactor 12, which could include raw influent, transporting channels, anaerobic zones, and anoxic zones. These measured parameters of the substance, such as wastewater, may include, by way of example, influent flow rate, influent flow content, chemical oxygen demand (COD), biochemical oxygen demand (BOD), total Kjeldahl nitrogen (TKN), ammonia-nitrogen (NH4-N), conductivity, total suspended solids (TSS), total phosphorus (TP), ortho phosphate (PO4-P), and temperature. In some embodiments, factors such as time of day or year may be considered, either alone or combination with other parameters or factors, in modifying aeration in some or all upstream zones. For example, such factors may include diurnal flow fluctuations, daily diurnal flow fluctuations, weekly diurnal flow fluctuations, monthly diurnal flow fluctuations, annual diurnal flow fluctuations, initial start-up versus design flow conditions, seasonal fluctuations in flow conditions, or combinations of any such factors.

In the same manner as described above, such aeration modifications to one or more upstream zones may be operated in series operation, sequence operation, or parallel operation. In series operation when there is increasing oxygen demand in the monitored aerated zone, the controller may sequentially raise the target DO value in an upstream zone to initiate or incrementally increase aeration in that zone to achieve and operate at such target DO value for that zone. Following a time period, the controller may again incrementally increase the target DO value for that same upstream zone if the monitored aerated zone remains at or above the maximum threshold. If an upstream zone undergoing aeration adjustment has achieved a maximum DO setpoint for that zone, the process may be repeated for another upstream zone in the same manner utilizing either Forward Order, Reverse Order, or Specified Order. However, at any point that the monitored aerated zone achieves its holding range, the existing aeration parameters within the system may be maintained until the monitored aerated zone is outside of its holding range.

By way of example with reference to FIG. 1A, in a Reverse Order series operation for increasing upstream aeration in a system in response to the monitored aerated zone conditions, the target DO value may be incrementally increased in zone 1A until a maximum DO setpoint is achieved. Subsequently, the target DO value may be incrementally increased in zone 1B until a maximum DO setpoint is achieved, and then target DO value may be incrementally increased in zone 1C until a maximum DO setpoint is achieved. As in the previously described embodiments, if at any time during a sequence operation the airflow rate for the monitored aerated zone is within its holding range, then aeration within the zones may be maintained in their current operating state until the airflow rate for the monitored aerated zone falls outside of the holding range, i.e., is at or below the minimum airflow rate or at or above the maximum airflow rate. For such an operation in Forward Order, such zones may be treated in the same manner in the order of zone 1C followed by zone 1B followed by zone 1A. As explained, in alternative embodiments, less than all upstream zones may be incrementally adjusted in a series operation. For such an operation in Specified Order, such zones may be treated in a similar manner as the upstream aeration decrease, where the order may be specified by the user in the controller 38, such as zone 1A followed by zone 1C followed by zone 1B or any order specified by the user. The specified order for aeration increase may be opposite that for aeration decrease or may be a different specified order all together.

Likewise, a sequence operation may take place in the same manner as above for increasing upstream aeration in a system in response to the monitored aerated zone conditions. For example, with reference to FIG. 1A, a Reverse Order sequence may involve incrementally increasing the target DO in zone 1A, followed by incrementally increasing the target DO value in zone 1B, followed by incrementally increasing the target DO value in zone 1C. This cycle may repeated until a maximum DO setpoint is achieved in any zone, at which point further increases to the target DO for that zone may be halted. In addition, as in the previously described embodiments, if at any time during a sequence operation the airflow rate for the monitored aerated zone is within its holding range, then aeration within the zones may be maintained in their current operating state until the airflow rate for the monitored aerated zone falls outside of the holding range, i.e., is at or below the minimum airflow rate or at or above the maximum airflow rate. For such an operation in Forward Order, such zones may be treated in the same manner in the order of zone 1C followed by zone 1B followed by zone 1A. As explained, in alternative embodiments, less than all upstream zones may be incrementally adjusted in a series operation. However, at any point that the monitored aerated zone achieves its holding range, the existing aeration parameters within the system may be maintained until the monitored aerated zone is outside of its holding range.

Similarly, parallel operation may be used for increasing aeration zones upstream from a monitored aerated environment when the monitored aerated environment has an airflow rate at or above the maximum threshold. In such parallel operation, a target DO value may be incrementally increased for each of multiple zones upstream of the monitored aerated environment, such as zones 1A, 1B, and 1C, or any combination thereof, in FIG. 1A. Following a delay, the controller may again incrementally increase the target DO value for those same upstream zones if the monitored aerated zone remains at or above the maximum threshold. If any upstream zone in the parallel operation achieves a maximum DO setpoint, the controller may stop increasing the target DO value for that zone. In addition, if the monitored aerated zone achieves its holding range at any point during the process, the existing aeration parameters within the system may be maintained until the monitored aerated zone is outside of its holding range.

### Dynamic Cycling

Given that a treatment process is dynamic, in some instances the parameters of the monitored aerated zone may change while the aeration to upstream zones is being decreased or increased in the manners described above. For example, substance in a particular zone at a particular time may vary based on influent flow rate, influent content, or time of day or time of year. For example, such factors may include diurnal flow fluctuations, daily diurnal flow fluctuations, weekly diurnal flow fluctuations, monthly diurnal flow fluctuations, annual diurnal flow fluctuations, initial start-up versus design flow conditions, seasonal fluctuations in flow conditions, or combinations of any such factors. Embodiments of the present invention may dynamically modify aeration based on actual conditions and, in some embodiments, reduce energy usage. Given such variations, the controller may dynamically change the aeration in such upstream zones based on the actual parameters of the monitored aerated zone. Thus, while the prior discussion has separately described decreasing or increasing aeration in zones upstream of the monitored aerated zone, the present invention contemplates that such operations will dynamically fluctuate between the manners described above based on varying influent flow rate, influent content, or time of day or time of year.

In some embodiments, dynamic cycling may be operated in Forward Order or Reverse Order for a series operation and/or for a sequence operation as described above. For Forward Order with respect to series operation or sequence operation, with reference to FIGS. 1A and 1B, the target DO values for the upstream zones are reduced in the order of zone 1A, followed by zone 1B, followed by zone 1C, and the target DO values for the upstream zones are increased in the order of zone 1C, followed by zone 1B, followed by zone 1A. Similarly, for Reverse Order with respect to series operation or sequence operation, the target DO values for the upstream zones are reduced in the order of zone 1C, followed by zone 1B, followed by zone 1A, and the target DO values for the upstream zones are increased in the order zone 1A, followed by zone 1B, followed by zone 1C. In both Forward Order and Reverse Order, the succession of adjusting the zones will vary depending upon whether the target DO values are being increased or decreased for the zones and the “Forward Order” and “Reverse Order” nomenclature indicates an overall succession of zones adjusted for the entire cycle with the ordering depending upon whether the target values are being increased or decreased.

When a series or sequence operation for a cyclical treatment process of the present invention is ongoing and transitions between decreasing target DO values in particular upstream zones, stable operation, and increasing target DO values in particular upstream zones, the process may resume adjusting target DO values at the last particular upstream zone that was adjusted and continue the operation in Forward Order or Reverse Order as indicated for that process. An example of such operation in dynamic conditions within a system is shown at t39 in Table 3 below.

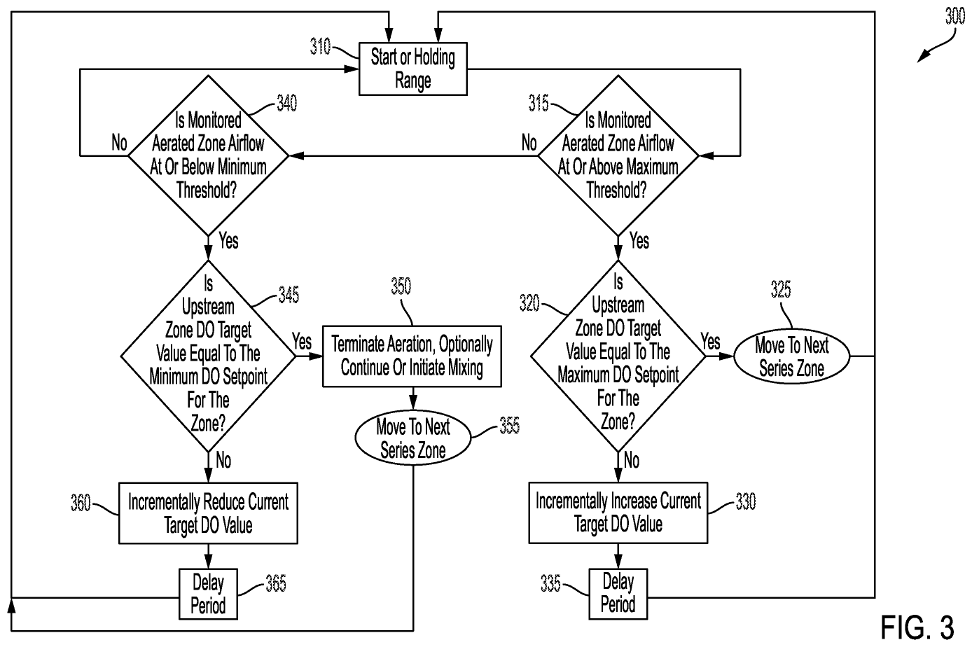

By way of example, FIG. 3 provides a schematic flow chart of an exemplary embodiment of a series treatment cycle of the present invention. As shown, that process 300 includes:
Step 310: The system is in a start or holding range.
Step 315: A determination is made as to whether the monitored aerated zone airflow is at or above a maximum threshold. If the monitored aerated zone airflow is at or above a maximum threshold, the process proceeds to step 320. If the monitored aerated zone airflow is not at or above a maximum threshold, the process proceeds to step 340.
Step 320: A determination is made as to whether a particular upstream zone DO target value is equal to the maximum setpoint for the zone. In series operation, this step may be performed for a particular upstream zone, which may be determined depending on if the process is operating in Forward Order or Reverse Order. If the particular upstream zone DO target value is equal to the maximum setpoint for the zone, the process proceeds to step 325. If the particular upstream zone DO target value is not equal to the maximum setpoint for the zone, the process proceeds to step 330.
Step 325: If the particular upstream zone DO target value was determined to be equal to the maximum setpoint for the zone in step 320, then the process may continue at step 325 by returning to step 310 for operation for the next upstream zone determined by the Forward Order or Reverse Order operation.
Step 330: If the particular upstream zone DO target value was not equal to the maximum setpoint for the zone in step 320, the target DO value for that zone is incrementally increased.
Step 335: Following step 330, an optional delay period may be imposed during which the aeration parameters to the particular upstream zones are maintained. Following step 335, the process returns to step 310.
Step 340: If the monitored aerated zone airflow is not at or above a maximum threshold in step 315, then a determination is made as to whether the monitored aerated zone airflow is at or below a minimum threshold. If the monitored aerated zone airflow is at or below a minimum threshold, the process proceeds to step 345. If the monitored aerated zone airflow is not at or below a minimum threshold, the process returns to step 310.
Step 345: A determination is made as to whether a particular upstream zone DO target value is equal to the minimum setpoint for the zone. In series operation, this step may be performed for a particular upstream zone, which may be determined depending on if the process is operating in Forward Order or Reverse Order. If the particular upstream zone DO target value is equal to the minimum setpoint for the zone, the process proceeds to step 350. If the particular upstream zone DO target value is not equal to the minimum setpoint for the zone, the process proceeds to step 360.
Step 350: If the particular upstream zone DO target value was determined to be equal to the minimum setpoint for the zone in step 345, then aeration is terminated for that particular zone in the series operation and mixing in that zone may be initiated or continued. The process continues to step 355.
Step 355: The series operation is continued for the next zone in the series operation, which may begin at step 310.
Step 360: If the particular upstream zone DO target value was determined to not be equal to the minimum setpoint for the zone in step 345, then the target DO value for that zone may be incrementally reduced.
Step 365: Following step 360, an optional delay period may be imposed during which the aeration parameters to the upstream zones are maintained. Following the optional step 365, the process returns to step 310.

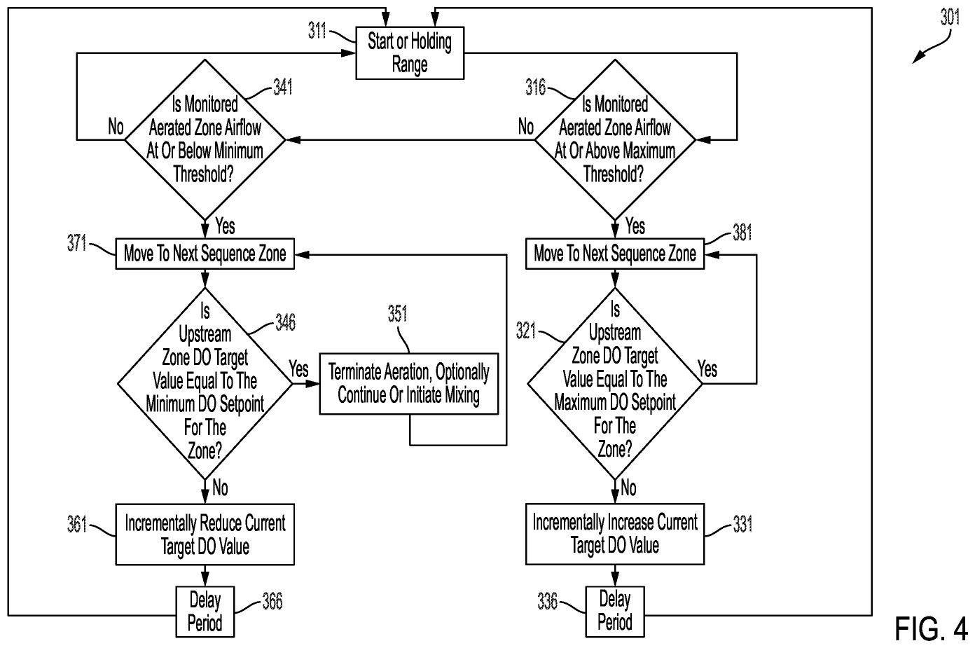

By way of another example, FIG. 4 provides a schematic flow chart of an exemplary embodiment of a sequence treatment cycle of the present invention. As shown, that process 301 includes:
Step 311: The system is in a start or holding range.
Step 316: A determination is made as to whether the monitored aerated zone airflow is at or above a maximum threshold. If the monitored aerated zone airflow is at or above a maximum threshold, the process proceeds to step 381. If the monitored aerated zone airflow is not at or above a maximum threshold, the process proceeds to step 341.
Step 381: In sequence operation, the system will automatically move to the next zone in the sequence to make a modification. This differs from series operation when the system does not progress to the next zone until the maximum DO setpoint is reached in a particular zone.
Step 321: A determination is made as to whether the particular upstream zone DO target value is equal to the maximum setpoint for the zone. In sequence operation, this step may be performed for a particular upstream zone, which may be determined depending on if the process is operating in Forward Order or Reverse Order. If the particular upstream zone DO target value is equal to the maximum setpoint for the zone, the process returns to step 381 to proceed to the next sequence zone. If the particular upstream zone DO target value is not equal to the maximum setpoint for the zone, the process proceeds to step 331.
Step 331: If the particular upstream zone DO target value was not equal to the maximum setpoint for the zone in step 321, the target DO value for that zone is incrementally increased.
Step 336: Following step 331, an optional delay period may be imposed during which the aeration parameters to the upstream zones are maintained. Following step 336, the process returns to step 311.
Step 341: If the monitored aerated zone airflow is not at or above a maximum threshold in step 316, then a determination is made as to whether the monitored aerated zone airflow is at or below a minimum threshold. If the monitored aerated zone airflow is at or below a minimum threshold, the process proceeds to step 371. If the monitored aerated zone airflow is not at or below a minimum threshold, the process returns to step 311.
Step 371: In sequence operation, the system will automatically move to the next zone in the sequence to make a modification. This differs from series operation when the system does not progress to the next zone until the maximum DO setpoint is reached in the particular zone.
Step 346: A determination is made as to whether the particular upstream zone DO target value is equal to the maximum setpoint for the zone. In sequence operation, this step may be performed for a particular upstream zone, which may be determined depending on if the process is operating in Forward Order or Reverse Order. If the particular upstream zone DO target value is equal to the minimum setpoint for the zone, the process proceeds to step 351. If the particular upstream zone DO target value is not equal to the minimum setpoint for the zone, the process proceeds to step 361.
Step 351: If the particular upstream zone DO target value was determined to be equal to the minimum setpoint for the zone in step 346, then aeration is terminated for that particular zone in the sequence operation and mixing in that zone may be initiated or continued. The process proceeds to step 371.
Step 361: If the particular upstream zone DO target value was determined to not be equal to the minimum setpoint for the zone in step 346, then the target DO value for that zone may be incrementally reduced.
Step 366: Following step 361, an optional delay period may be imposed during which the aeration parameters to the upstream zones are maintained. Following step 366, the process returns to step 311.

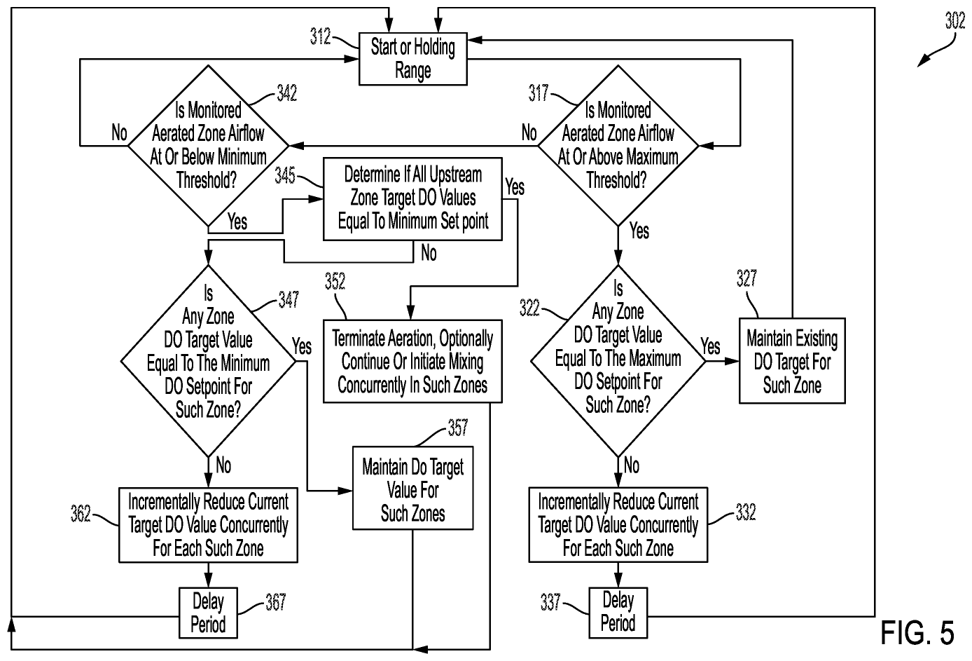

In still another example, FIG. 5 provides a schematic flow chart of an exemplary embodiment of a parallel treatment cycle of the present invention. As shown, that process 302 includes:
Step 312: The system is in a start or holding range.
Step 317: A determination is made as to whether the monitored aerated zone airflow is at or above a maximum threshold. If the monitored aerated zone airflow is at or above a maximum threshold, the process proceeds to step 322. If the monitored aerated zone airflow is not at or above a maximum threshold, the process proceeds to step 342.
Step 322: A determination is made as to whether the upstream zone DO target value is equal to the maximum setpoint for such zone. This determination may be made for each particular upstream zone in the parallel treatment operation. If an upstream zone DO target value is equal to the maximum setpoint for any zone, the process proceeds to step 327 for such zones. If the upstream zone DO target value is not equal to the maximum setpoint for any zone, the process proceeds to step 332 for such zones.
Step 327: The system maintains the DO target value for such zone and the process returns to step 312 for that zone to be included when the cycle repeats.
Step 332: If the DO target value for a particular zone was not equal to the maximum setpoint for a zone in step 322, the target DO value in such zones is incrementally and concurrently increased for each such zone.
Step 337: Following step 332, an optional delay period may be imposed during which the aeration parameters to the upstream zones are maintained. Following step 337, the process returns to step 312.
Step 342: If the monitored aerated zone airflow is not at or above a maximum threshold in step 317, then a determination is made as to whether the monitored aerated zone airflow is at or below a minimum threshold. If the monitored aerated zone airflow is at or below a minimum threshold, the process proceeds to step 345. If the monitored aerated zone airflow is not at or below a minimum threshold, the process returns to step 312.
Step 345: A determination is made as to whether all upstream zone DO target values involved in the parallel operation are equal to the respective minimum setpoint for each such zone. If all upstream zone DO target values are equal to the minimum setpoint, the process proceeds for step 352. If all upstream zone DO target values are not equal to the minimum setpoint, the process proceeds to step 347.
Step 352: If all upstream zone DO target values were determined to be equal to the minimum setpoint for all zones in step 345, then aeration is terminated for all zones, wherein such termination may be concurrent for all such parallel zones or in series as the cycle repeats, and mixing in such zones may be initiated or continued. The process then returns to step 312.
Step 347: A determination is made as to whether the particular upstream zone DO target value is equal to the minimum setpoint for that zone. This step may be performed for each upstream zone. If the upstream zone DO target value is equal to the minimum setpoint for any zone, the process proceeds to step 357 such zones. If the upstream zone DO target value is not equal to the minimum setpoint for any zone, the process proceeds to step 362 for such zones.
Step 357: The system maintains the DO target value for such zone and the process returns to step 312 for that zone to be included when the cycle repeats.
Step 362: If the upstream zone DO target value was determined to not be equal to the minimum setpoint for such zone in step 347, then the target DO value for that zone may be incrementally reduced.
Step 367: Following step 362, an optional delay period may be imposed during which the aeration parameters to the upstream zones are maintained. Following step 367, the process returns to step 312.

By way of example, a hypothetical exemplary parallel operation of the system in FIG. 1A is provided below. Table 1 provides sample maximum DO setpoints and minimum DO setpoints for zones 1A, 1B, and 1C of FIG. 1A, and Table 2 provides illustrative parameters for those zones over a period of time during operation:

TABLE 1

| Example Setpoints | Zone 1A | Zone 1B | Zone 1C |
|---|---|---|---|
| Maximum DO Setpoint | 1 | 1.4 | 2.2 |
| Minimum DO Setpoint | 0.2 | 0.4 | 0.8 |

TABLE 2

| | | | Zone 1A | Zone 1B | Zone 1C |
|---|---|---|---|---|---|
| | | Changing Target | DO | DO | DO |
| Time | Monitored Aerated | Values based on | Target | Target | Target |
| Period | Zone Airflow Status | Oxygen Demand | Value | Value | Value |
| t0 | Starting Value | Starting Value | 0.2 | 0.4 | 0.8 |
| t1 | Above Holding Range | Increasing Demand | 0.3 | 0.5 | 0.9 |
| t2 | Above Holding Range | Increasing Demand | 0.4 | 0.6 | 1.0 |
| t3 | Above Holding Range | Increasing Demand | 0.5 | 0.7 | 1.1 |
| t4 | Above Holding Range | Increasing Demand | 0.6 | 0.8 | 1.2 |
| t5 | Above Holding Range | Increasing Demand | 0.7 | 0.9 | 1.3 |
| t6 | Above Holding Range | Increasing Demand | 0.8 | 1.0 | 1.4 |
| t7 | Above Holding Range | Increasing Demand | 0.9 | 1.1 | 1.5 |
| t8 | Above Holding Range | Increasing Demand | 1.0 | 1.2 | 1.6 |
| t9 | Above Holding Range | Increasing Demand | 1.0 | 1.3 | 1.7 |
| t10 | Above Holding Range | Increasing Demand | 1.0 | 1.4 | 1.8 |
| t11 | Above Holding Range | Increasing Demand | 1.0 | 1.4 | 1.9 |
| t12 | Above Holding Range | Increasing Demand | 1.0 | 1.4 | 2.0 |
| t13 | Within Holding Range | Stable Demand | 1.0 | 1.4 | 2.0 |
| t14 | Below Holding Range | Decreasing Demand | 0.9 | 1.3 | 1.9 |
| t15 | Below Holding Range | Decreasing Demand | 0.8 | 1.2 | 1.8 |
| t16 | Below Holding Range | Decreasing Demand | 0.7 | 1.1 | 1.7 |
| t17 | Below Holding Range | Decreasing Demand | 0.6 | 1.0 | 1.6 |
| t18 | Below Holding Range | Decreasing Demand | 0.5 | 0.9 | 1.5 |
| t19 | Below Holding Range | Decreasing Demand | 0.4 | 0.8 | 1.4 |
| t20 | Below Holding Range | Decreasing Demand | 0.3 | 0.7 | 1.3 |
| t21 | Below Holding Range | Decreasing Demand | 0.2 | 0.6 | 1.2 |
| t22 | Below Holding Range | Decreasing Demand | 0.2 | 0.5 | 1.1 |
| t23 | Below Holding Range | Decreasing Demand | 0.2 | 0.4 | 1.0 |
| t24 | Below Holding Range | Decreasing Demand | 0.2 | 0.4 | 0.9 |
| t25 | Below Holding Range | Decreasing Demand | 0.2 | 0.4 | 0.8 |
| t26 | Within Holding Range | Stable Demand | 0.2 | 0.4 | 0.8 |

As shown above in Table 2, each row above may represent a point in time followed by a period of delay before the time period indicated by the next row. During the period of increasing aeration in the upstream zones, zone 1A achieved its maximum DO setpoint at t8 and the target DO value was maintained for that zone. Similarly, zone 1B achieved its maximum DO setpoint at t10 and the target DO value was maintained for that zone. Zone 1C did not achieve its maximum DO setpoint and incremental target DO value increases continued until the monitored aerated zone was in its holding range, at which time the system maintained its aeration parameters at t13. However, the modified aerated zone subsequently indicated that it had reached or fallen below its minimum airflow rate at t14 and, as a result, incremental reduction of aeration in the upstream zones 1A, 1B, and 1C was commenced. Zone 1A and zone 1B reached their minimum DO setpoints at t21 and t23, respectively, and further target DO value reductions to those zones were suspended at those respective times, whereas such incremental target DO value decreases for zone 1C continued until t25. The foregoing example is merely an illustrative portion of a process, and the process may continue with such dynamic adjustments based on the measured airflow in the monitored aerated zone.

Using the same illustrative parameters of Table 1 above, the following Table 3 illustrates a hypothetical exemplary Forward Order series operation of the system in FIG. 1A over a different period of time during operation:

TABLE 3

| | | | Zone 1A | Zone 1B | Zone 1C |
|---|---|---|---|---|---|
| | | Changing Target | DO | DO | DO |
| Time | Monitored Aerated | Values based on | Target | Target | Target |
| Period | Zone Airflow Status | Oxygen Demand | Value | Value | Value |
| t0 | Starting Value | Starting Value | 0.2 | 0.4 | 0.8 |
| t1 | Above Holding Range | Increasing Demand | 0.3 | 0.4 | 0.8 |
| t2 | Above Holding Range | Increasing Demand | 0.4 | 0.4 | 0.8 |
| t3 | Above Holding Range | Increasing Demand | 0.5 | 0.4 | 0.8 |
| t4 | Above Holding Range | Increasing Demand | 0.6 | 0.4 | 0.8 |
| t5 | Above Holding Range | Increasing Demand | 0.7 | 0.4 | 0.8 |
| t6 | Above Holding Range | Increasing Demand | 0.8 | 0.4 | 0.8 |
| t7 | Above Holding Range | Increasing Demand | 0.9 | 0.4 | 0.8 |
| t8 | Above Holding Range | Increasing Demand | 1.0 | 0.4 | 0.8 |
| t9 | Above Holding Range | Increasing Demand | 1.0 | 0.5 | 0.8 |
| t10 | Above Holding Range | Increasing Demand | 1.0 | 0.6 | 0.8 |
| t11 | Above Holding Range | Increasing Demand | 1.0 | 0.7 | 0.8 |
| t12 | Above Holding Range | Increasing Demand | 1.0 | 0.8 | 0.8 |
| t13 | Above Holding Range | Increasing Demand | 1.0 | 0.9 | 0.8 |
| t14 | Above Holding Range | Increasing Demand | 1.0 | 1.0 | 0.8 |
| t15 | Above Holding Range | Increasing Demand | 1.0 | 1.1 | 0.8 |
| t16 | Above Holding Range | Increasing Demand | 1.0 | 1.2 | 0.8 |
| t17 | Above Holding Range | Increasing Demand | 1.0 | 1.3 | 0.8 |
| t18 | Above Holding Range | Increasing Demand | 1.0 | 1.4 | 0.8 |
| t19 | Above Holding Range | Increasing Demand | 1.0 | 1.4 | 0.9 |
| t20 | Above Holding Range | Increasing Demand | 1.0 | 1.4 | 1.0 |
| t21 | Above Holding Range | Increasing Demand | 1.0 | 1.4 | 1.1 |
| t22 | Above Holding Range | Increasing Demand | 1.0 | 1.4 | 1.2 |
| t23 | Above Holding Range | Increasing Demand | 1.0 | 1.4 | 1.3 |
| t24 | Above Holding Range | Increasing Demand | 1.0 | 1.4 | 1.4 |
| t25 | Above Holding Range | Increasing Demand | 1.0 | 1.4 | 1.5 |
| t26 | Within Holding Range | Stable Demand | 1.0 | 1.4 | 1.5 |
| t27 | Within Holding Range | Stable Demand | 1.0 | 1.4 | 1.5 |
| t28 | Below Holding Range | Decreasing Demand | 1.0 | 1.4 | 1.4 |
| t29 | Below Holding Range | Decreasing Demand | 1.0 | 1.4 | 1.3 |
| t30 | Within Holding Range | Stable Demand | 1.0 | 1.4 | 1.3 |
| t31 | Below Holding Range | Decreasing Demand | 1.0 | 1.4 | 1.2 |
| t32 | Below Holding Range | Decreasing Demand | 1.0 | 1.4 | 1.1 |
| t33 | Within Holding Range | Stable Demand | 1.0 | 1.4 | 1.1 |
| t34 | Below Holding Range | Decreasing Demand | 1.0 | 1.4 | 1.0 |
| t35 | Below Holding Range | Decreasing Demand | 1.0 | 1.4 | 0.9 |
| t36 | Below Holding Range | Decreasing Demand | 1.0 | 1.4 | 0.8 |
| t37 | Within Holding Range | Stable Demand | 1.0 | 1.4 | 0.8 |
| t38 | Within Holding Range | Stable Demand | 1.0 | 1.4 | 0.8 |
| t39 | Above Holding Range | Increasing Demand | 1.0 | 1.4 | 0.9 |
| t40 | Above Holding Range | Increasing Demand | 1.0 | 1.4 | 1.0 |
| t41 | Above Holding Range | Increasing Demand | 1.0 | 1.4 | 1.1 |

As shown above in Table 3, each row above may represent a point in time followed by a period of delay before the time period indicated by the next row. During the period of increasing aeration in the upstream zones, zone 1A achieved its maximum DO setpoint at t8 and the target DO value was maintained for that zone. Similarly, zone 1B achieved its maximum DO setpoint at t18 and the target DO value was maintained for that zone. Zone 1C did not achieve its maximum DO setpoint and incremental target DO value increases continued until the monitored aerated zone was in its holding range, at which time the system maintained its aeration parameters at t26. However, the modified aerated zone subsequently indicated that it had reached or fallen below its minimum airflow rate at t28 and, as a result, incremental reduction of aeration in the upstream zone 1C was commenced. In addition, at t37 the system again reached stable demand and the last adjustment before stable demand was zone 1C at t36. As such, when the system is outside the holding range and has increasing demand at t39, zone 1C was the first zone considered for adjustment in the series operation, which is then continued to t41. The foregoing example is merely an illustrative portion of a process, and the process may continue with such dynamic adjustments based on the measured airflow in the monitored aerated zone. In different embodiments, adjusting target DO may be done in Forward Order or in Reverse Order. In yet another alternative embodiment using a sequence operation, any increases or decreases to target DO values in zones 1A, 1B, and 1C could be done in sequence operation as explained above instead of the series operation shown in Table 3 above.

By way of further example, another hypothetical exemplary parallel operation of the system in FIG. 1A is provided below. Table 4 provides sample maximum DO setpoints and minimum DO setpoints for zones 1A, 1B, and 1C of FIG. 1A, and Table 5 provides illustrative parameters for those zones over a period of time during operation:

TABLE 4

| Example Setpoints | Zone 1A | Zone 1B | Zone 1C |
|---|---|---|---|
| Maximum DO Setpoint | 1 | 1.4 | 2.2 |
| Minimum DO Setpoint | 0.2 | 0.4 | 0.8 |

TABLE 5

| | | | Zone 1A | Zone 1B | Zone 1C |
|---|---|---|---|---|---|
| | | Changing Target | DO | DO | DO |
| Time | Monitored Aerated | Values based on | Target | Target | Target |
| Period | Zone Airflow Status | Oxygen Demand | Value | Value | Value |
| t0 | Starting Value | Starting Value | 0.2 | 0.4 | 0.8 |
| t1 | Above Holding Range | Increasing Demand | 0.3 | 0.5 | 0.9 |
| t2 | Above Holding Range | Increasing Demand | 0.4 | 0.6 | 1.0 |
| t3 | Within Holding Range | Stable Demand | 0.4 | 0.6 | 1.0 |
| t4 | Within Holding Range | Stable Demand | 0.4 | 0.6 | 1.0 |
| t5 | Below Holding Range | Decreasing Demand | 0.3 | 0.5 | 0.9 |
| t6 | Below Holding Range | Decreasing Demand | 0.2 | 0.4 | 0.8 |
| t7 | Within Holding Range | Stable Demand | 0.2 | 0.4 | 0.8 |
| t8 | Above Holding Range | Increasing Demand | 0.3 | 0.5 | 0.9 |
| t9 | Within Holding Range | Stable Demand | 0.3 | 0.5 | 0.9 |
| t10 | Below Holding Range | Decreasing Demand | 0.2 | 0.4 | 0.8 |
| t11 | Below Holding Range | Decreasing Demand | 0.2 | 0.4 | 0.8 |
| t12 | Within Holding Range | Stable Demand | 0.2 | 0.4 | 0.8 |
| t13 | Within Holding Range | Stable Demand | 0.2 | 0.4 | 0.8 |

As shown above in Table 5, each row above may represent a point in time followed by a period of delay before the time period indicated by the next row. The description above is similar to Table 2 for this example, however the changes are more frequent between increasing demand, stable demand, and decreasing demand. During the period of decreasing target DO values in the upstream zones at t11, it is notable that all three zones reached their minimum DO setpoints and did not decrease. At this time, aeration may be terminated in zone 1A, zone 1B and zone 1C and operation of mixing devices may be continued or initiated. Subsequently at t12, aeration in zone 1A, zone 1B and zone 1C may continue to be terminated or terminated if not previously terminated and operation of mixing devices may be continued or initiated while the monitored aerated zone airflow status remains in its holding range. The foregoing example is merely an illustrative portion of a process, and the process may continue with such dynamic adjustments based on the measured airflow in the monitored aerated zone.

By way of further example, another hypothetical exemplary parallel operation of the system in FIG. 1A is provided below. In this example, only one dissolved oxygen sensor is present in the combined zones 1A, 1B, and 1C and said sensor is used to adjust the dissolved oxygen target for all three zones. Table 6 provides sample maximum DO setpoints and minimum DO setpoints for zones 1A, 1B, and 1C of FIG. 1A and Table 7 provides illustrative parameters for those zones over a period of time during operation:

TABLE 6

| Example Setpoints | Zone 1A/1B/1C |
|---|---|
| Maximum DO Setpoint | 2.0 |
| Minimum DO Setpoint | 0.5 |

TABLE 7

| | Monitored | Changing Target | Zone |
|---|---|---|---|
| Time | Aerated | Values based on | 1A/1B/1C |
| Period | Zone Status | Oxygen Demand | DO Target Value |
| t0 | Starting Value | Starting Value | 0.5 |
| t1 | Above Holding Range | Increasing Demand | 0.6 |
| t2 | Above Holding Range | Increasing Demand | 0.7 |
| t3 | Within Holding Range | Stable Demand | 0.7 |
| t4 | Within Holding Range | Stable Demand | 0.7 |
| t5 | Below Holding Range | Decreasing Demand | 0.6 |
| t6 | Below Holding Range | Decreasing Demand | 0.5 |
| t7 | Below Holding Range | Decreasing Demand | 0.5 |
| t8 | Above Holding Range | Increasing Demand | 0.6 |
| t9 | Above Holding Range | Increasing Demand | 0.7 |
| t10 | Above Holding Range | Increasing Demand | 0.8 |
| t11 | Above Holding Range | Increasing Demand | 0.9 |
| t12 | Within Holding Range | Stable Demand | 0.9 |
| t13 | Within Holding Range | Stable Demand | 0.9 |

As shown above in Table 7, each row may represent a point in time followed by a period of delay before the time period indicated by the next row. The description above is similar for this example to the previous examples described tables for this example; however, in this example, all of the zones are operating at the same dissolved oxygen target values instead of at different dissolved oxygen target values. During the period of decreasing target DO values at t7, it is notable that upstream zones 1A, 1B. and 1C reached their minimum DO setpoints and did not decrease. At this time, aeration may be terminated in zone 1A, zone 1B, and zone 1C and operation of mixing devices may be continued or initiated. The foregoing example is merely an illustrative portion of a process, and the process may continue with such dynamic adjustments based on the measured airflow in the monitored aerated zone.

As noted above, in some embodiments, increases or decreases to the target DO value of an upstream zone may only take place after the airflow in the monitored aerated zone has fallen outside of the holding range for a requisite period of time, which may be from 1 minute to 60 minutes (including each intermittent value therein).

As explained herein, zones upstream of a monitored aerated zone may have minimum DO setpoints and maximum DO setpoints that are utilized in the embodiments of the present invention. In some embodiments, the maximum DO setpoint may be based on a select value determined by one skilled in the art. In other embodiments, the maximum DO setpoint may be a factor of the minimum DO setpoint for the zone, such as two or three times the minimum DO setpoint. In yet other embodiments the maximum DO setpoint in a zone may be a percentage of the DO setpoint used in the monitored aerated zone, such as 70%, 50% or 30% of the monitored aerated zone or any value within 0-100% of the DO setpoint used in the monitored aerated zone. The percentage used may be based on the location of the zone compared to the monitored aerated zone and how far upstream the zone is from the monitored aerated zone. Regardless of how the maximum DO setpoint is determined, the value may be the same in all zones, same in one or more zones, or completely different in each zone. In some embodiments, the maximum DO setpoint may increase in each zone the closer it is located to the monitored aerated zone.

In some embodiments the minimum DO setpoint may be based on a select value determined by one skilled in the art. In other embodiments, the minimum DO setpoint may be a fraction of the maximum DO setpoint for the zone, such as half or one third of the maximum DO setpoint. In yet other embodiments the minimum DO setpoint in a zone may be a percentage of the DO setpoint used in the monitored aerated zone, such as 70%, 50% or 30% of the monitored aerated zone or any value within 0-100% of the DO setpoint used in the monitored aerated zone. The percentage used may be based on the location of the zone compared to the monitored aerated zone and how far upstream the zone is from the monitored aerated zone. Regardless of how the minimum DO setpoint is determined, the value may be the same in all zones, same as one or more zones, or completely different in each zone. The minimum DO setpoint may increase in each zone the closer it is located to the monitored aerated zone.

In yet still other embodiments, the maximum and minimum DO setpoints may be selected at a lower value such as 0.2 or 0.3 or 0.4 mg/L to promote a suboxic or low DO environment to encourage simultaneous nitrification and denitrification. Alternatively, the maximum and minimum DO setpoints may be selected at a higher value such as 1.0, 1.5 or 2.0 mg/L to promote an aerobic environment to encourage carbon removal and nitrification. In addition, the minimum DO setpoint may be selected at a lower value to promote suboxic or low DO environment, while the maximum DO setpoint may be selected at a higher value to promote an aerobic environment. In yet still other embodiments, the maximum and minimum DO setpoints may be selected at values equal to each other, whereas the target DO setpoint will not change because the maximum is equal to the minimum and there is no difference in the values.

In yet still other embodiments, a single maximum and minimum DO setpoint may be used for control of multiple zones. When a zone does not include a DO sensor, the modulating valve 34 may be controlled directly to the same airflow target or valve position as the other zone that includes a DO sensor. In yet still other embodiments, the modulating valve 34 of said zone that does not include a DO sensor may be controlled based on a ratio of the airflow target or valve position as another zone that includes a DO sensor. In this example, such ratio may be greater than or equal to or less than 1, such that the valve adjustment is greater than or equal to or less than the valve adjustment of said other zone.

In yet still other embodiments, a reactor 12 may be one of a larger system 10 including a group of many reactors 12 operated in parallel where wastewater enters each inlet 20 at the same time. As such, the foregoing description of illustrative embodiment of the invention can be applied to the group of reactors individually, or with a lead reactor where the monitored aerated zone of the lead reactor may control the upstream zones in all the reactors, not just the upstream zones of the lead reactor.

Systems and methods of the present invention may be utilized in numerous other treatment systems based on the foregoing disclosure. For example, FIGS. 1-7 of U.S. Pat. No. 11,993,524, which is incorporated herein in its entirety by reference, provide additional exemplary embodiments of wastewater treatment systems in which the present invention may be implemented using the foregoing description. In such embodiments, zones may exist in the areas shown in such figures, or additional or alternative header and valve and valve placements could be utilized to define zones in a different configuration as described above.

Although the foregoing description has been provided in the context of a wastewater treatment process, other applications unrelated to wastewater treatment are within the scope of the present invention. As such, the foregoing description of illustrative embodiments of the invention has been presented only for the purpose of illustration and description and is not intended to be exhaustive or to limit the invention to the precise forms disclosed. Numerous modifications and adaptations thereof will be apparent to those of ordinary skill in the art without departing from the scope of the present invention.

1. A method for a wastewater treatment process comprising:
monitoring an oxygen demand in a first zone of a reactor;
dynamically adjusting a target dissolved oxygen value for a plurality of second zones that are upstream of the first zone by:
incrementally decreasing the target dissolved oxygen value for one or more of the plurality of second zones in response to a measured oxygen demand of the first zone being at or below a minimum threshold,
incrementally increasing the target dissolved oxygen value for one or more of the plurality of second zones in response to a measured oxygen demand of the first zone is at or exceeds a maximum threshold, and
maintaining the target dissolved oxygen value for the plurality of second zones when the oxygen demand of the first zone is between the minimum threshold and the maximum threshold.

2. The method of claim 1 wherein the maximum threshold for the first zone is based on a combination of a maximum dissolved oxygen concentration in the first zone and a reactor total airflow.

3. The method of claim 1 wherein the maximum threshold for the first zone is a maximum dissolved oxygen concentration in the first zone.

4. The method of claim 1 wherein the maximum threshold for the first zone is a maximum airflow rate for the first zone.

5. The method of claim 1 wherein the minimum threshold for the first zone is a minimum dissolved oxygen concentration in the first zone.

6. The method of claim 1 wherein the minimum threshold for the first zone is based on combination of a minimum dissolved oxygen concentration in the first zone and a reactor total airflow.

7. The method of claim 1 wherein the minimum threshold for the first zone is a minimum airflow rate for the first zone.

8. The method of claim 1 wherein the step of dynamically adjusting a target dissolved oxygen value for a plurality of second zones is initiated after the measured oxygen demand of the first zone is at or below a minimum threshold or is at or exceeds a maximum threshold for a requisite period of time.

9. The method of claim 1 wherein the incremental increasing and decreasing of the target dissolved oxygen value for the plurality of second zones is conducted in a series operation.

10. The method of claim 9 wherein the series operation is conducted from an influent end of the reactor to an effluent end of the reactor.

11. The method of claim 9 wherein the series operation is conducted from an effluent end of the reactor to an influent end of the reactor.

12. The method of claim 1 wherein the incremental increasing and decreasing of the target dissolved oxygen for the second zones is conducted in a sequence operation.

13. The method of claim 12 wherein the sequence operation is conducted from an influent end of the reactor to an effluent end of the reactor.

14. The method of claim 12 wherein the sequence operation is conducted from an effluent end of the reactor to an influent end of the reactor.

15. The method of claim 1 wherein the incremental increasing and decreasing of the target dissolved oxygen for the second zones is conducted in a specified order operation.

16. The system of claim 1 wherein one or more of the steps of incrementally decreasing the target dissolved oxygen value for one or more of the plurality of second zones and the step of incrementally increasing the target dissolved oxygen value for one or more of the plurality of second zones is based at least in part on one or more of:
parameters measured at an inlet of the reactor or a position prior to the reactor 12, wherein such parameters comprise influent flow rate, influent flow content, chemical oxygen demand, biochemical oxygen demand, total Kjeldahl nitrogen, ammonia-nitrogen, conductivity, total suspended solids, total phosphorus, ortho phosphate, temperature, and combinations thereof; and
timing parameters comprising diurnal flow fluctuations, daily diurnal flow fluctuations, weekly diurnal flow fluctuations, monthly diurnal flow fluctuations, annual diurnal flow fluctuations, initial start-up versus design flow conditions, seasonal fluctuations in flow conditions, or combinations thereof.

17. The method of claim 1 wherein incremental increasing and decreasing of the target dissolved oxygen for the second zones is conducted in a parallel operation.

18. The method of claim 1 further comprising ceasing incrementally decreasing the target dissolved oxygen value to any one or more of the plurality of second zones upon a measured minimum dissolved oxygen setpoint of a substance in that zone.

19. The method of claim 1 further comprising ceasing incrementally increasing the target dissolved oxygen value to any one or more of the plurality of second zones upon a measured maximum dissolved oxygen setpoint of a substance in that zone.

20. The method of claim 1 further comprising a delay period after any incremental increase or decrease in the target dissolved oxygen value.

21. The method of claim 1 further comprising operating mixing devices in at least one second zone concurrently with delivering aeration gas in that at least one second zone.

22. The method of claim 1 further comprising halting the operation of any mixing devices in at least one second zone when delivering aeration gas in that at least one second zone.

23. A control system for a wastewater treatment process comprising:
a reactor comprising a first zone and a plurality of second zones,
one or more aeration devices positioned within the first zone and each of the plurality of second zones,
one or more airflow rate meters connected with the aeration devices in the first zone and configured for monitoring the flow rate of aeration gas to the aeration devices in the first zone of the reactor,
an adjustable flow control device for each of the plurality of second zones that is connected with the aeration devices in that second zone,
a dissolved oxygen sensor connected with each of the plurality of second zones,
a controller configured to continually
decrease a dissolved oxygen target in one or more of the plurality of second zones to a reduced dissolved oxygen target in response to the oxygen demand of a substance in the first zone being at or below a minimum threshold,
adjust one or more flow control devices to decrease the delivery of aeration gas to satisfy the reduced dissolved oxygen target,
increase a dissolved oxygen target in one or more of the plurality of second zones to an increased dissolved oxygen target in response to the oxygen demand of a substance in the first zone being at or above a maximum threshold,
adjust one or more flow control devices to increase the delivery of aeration gas to satisfy an increased dissolved oxygen target, and
maintain the status of the flow control devices when the oxygen demand of the substance in the first zone is between the minimum threshold and the maximum threshold.

24. The system of claim 23 wherein the controller is configured to decrease the dissolved oxygen target in the plurality of second zones to a reduced dissolved oxygen target, to adjust the one or more flow control devices to decrease the delivery of aeration gas to a reduced dissolved oxygen target in the plurality of second zones, to increase the dissolved oxygen target in the plurality of second zones to an increased dissolved oxygen target, and to adjust one or more flow control devices to increase the delivery of aeration gas in the plurality of second zones in a series operation.

25. The system of claim 24 wherein the controller is configured to conduct the series operation from an influent end of the reactor to an effluent end of the reactor.

26. The system of claim 24 wherein the controller is configured to conduct the series operation from an effluent end of the reactor to an influent end of the reactor.

27. The system of claim 23 wherein the controller is configured to decrease the dissolved oxygen target in the plurality of second zones to a reduced dissolved oxygen target, to adjust the one or more flow control devices to decrease the delivery of aeration gas to a reduced dissolved oxygen target in the plurality of second zones, to increase the dissolved oxygen target in the plurality of second zones to an increased dissolved oxygen target, and to adjust one or more flow control devices to increase the delivery of aeration gas in the plurality of second zones in a sequence operation.

28. The system of claim 27 wherein the controller is configured to conduct the sequence operation from an influent end of the reactor to an effluent end of the reactor.

29. The system of claim 27 wherein the controller is configured to conduct the sequence operation from an effluent end of the reactor to an influent end of the reactor.

30. The system of claim 23 wherein the controller is configured to decrease the dissolved oxygen target in the plurality of second zones to a reduced dissolved oxygen target, to adjust the one or more flow control devices to decrease the delivery of aeration gas to a reduced dissolved oxygen target in the plurality of second zones, to increase the dissolved oxygen target in the plurality of second zones to an increased dissolved oxygen target, and to adjust one or more flow control devices to increase the delivery of aeration gas in the plurality of second zones in a parallel operation.

31. The system of claim 23 wherein the controller is configured to cease decreasing the dissolved oxygen target in one or more of the plurality of second zones upon a measured minimum dissolved oxygen setpoint of a substance in that zone.

32. The system of claim 23 wherein the controller is configured to cease increasing the dissolved oxygen target in one or more of the plurality of second zones upon a measured maximum dissolved oxygen setpoint of a substance in that zone.

33. The system of claim 23 wherein the controller is further configured to impose a delay period during which the target dissolved oxygen is maintained in the second zones after any incremental increase or decrease in the target dissolved oxygen value for one or more of the second zones.

34. The system of claim 23 wherein the controller is further configured to initiate or continue the operation of mixing devices in at least one second zone concurrently when aeration gas is being delivered in that at least one second zone.

35. The system of claim 23 wherein the controller is further configured to cease any operation of any mixing devices in at least one second zone when aeration gas is being delivered in that at least one second zone.
